(19) United States
(12) Patent Application Publication
(10) Pub. No.: US 2002/0147967 A1
(43) Pub. Date: Oct. 10, 2002

(54) Operating software scheduling priority recorder

(75) Inventor: Ralph E. Frazier, Suwanee, GA (US)

Correspondence Address: Paul W. Martin, NCR Corporation, Law Department, 101 W. Schantz Avenue, ECD-2, Dayton, OH, 45479-0001, US

(73) Assignee: NCR CORPORATION

(21) Appl. No.: 09/782,151

(22) Filed: Feb. 14, 2001

(51) Int. Cl. G06F 9/44

(52) U.S. Cl. 717/127; 717/130

(57) ABSTRACT

A method and apparatus for recording operating software program scheduling information while the operating software is executing are described. The scheduling information is captured without requiring additional hardware or software. A recording mechanism is compiled, integrated with and comprises a part of the operating software.

### RELATED APPLICATION

The present application is related to co-pending patent application entitled “Operating Software Performance Monitor” NCR Docket No. 8686, assigned to the instant assignee and filed on even date herewith and is hereby incorporated by reference into this specification in its entirety.

### FIELD OF THE INVENTION

The present invention relates generally to the recording of operating software program scheduling information while the operating software is executing, and more particularly, to a method and apparatus for recording such scheduling information from within the operating software. Still more particularly, the present invention relates to such a method and apparatus requiring no external device to record such scheduling information.

### BACKGROUND OF THE INVENTION

Typical operating systems include a kernel having a variety of functions and services made available to applications, otherwise referred to as software, executable software, programs, tasks, or processes. Among the kernel components is a scheduler for deciding which application (task, process, etc.) to execute or run based on a priority scheme set in the operating system. The runtime priority scheme provides the ability to control or set the importance of an application. The higher the run-time priority, the more time is afforded to the application by the operating system, i.e., operating software. Further, in most cases, a lower priority application which is running will be preempted by the operating system for a higher priority application execution.

Accordingly, program scheduling priority schemes can be based on various approaches, or combination of approaches, such as dynamic, fixed, grouped, and unique priorities. The dynamic priority scheme is an approach where the application scheduling priority is raised or lowered according to the needs of the operating system. A fixed priority scheme is a situation where the application scheduling priority remains constant. An application can have a scheduling priority common to a group of applications. The scheduling priority scheme between applications with identical priorities is first-come, first-served. Also, it is possible for every application accessing the operating system to have a unique scheduling priority. To reiterate, the program scheduling priority scheme is dependent on the design of the operating software. However, the present inventor is unaware of any software built in current operating software for recording operating software scheduling information, i.e., counts, variables, or system structures that the operating software updates and maintains in conjunction with program, or application, scheduling. It would be beneficial to record scheduling information to allow for later analyses or for real time analyses. Thus, there is a need in the art to provide a mechanism to record the operating software's scheduling information.

Prior approaches to obtaining operating software scheduling information have depended on the use of external devices, such as logic analyzers, simulators, or emulators. The external devices are separate, stand-alone computer systems including operating software for obtaining operating software scheduling information from the operating software of a computer system under test. Typically, these devices are either attached to the computer system under test, or the software is imported to the external device. There is a risk that the external device will not behave exactly like the computer system under test. Connecting a device to an installed system is impractical as the installation and/or execution of the device interferes with the operation and use of the system. For example, additional interrupts may be generated for the device and may impact the quality and usefulness of the recorded scheduling information by increasing the system load due to the extra processing necessary to handle the interrupts. Thus, there is a further need in the art to provide the above described scheduling information recorder without using external devices.

### SUMMARY OF THE INVENTION

It is, therefore, an object of the present invention to provide a method and apparatus for recording operating software program scheduling information while the operating software is executing.

Another object of the present invention is to provide a mechanism to record operating software program scheduling information without using an external device.

The present invention provides a method and apparatus for recording operating software program scheduling information while the operating software is executing. Further, the scheduling information is captured by an operating software scheduling priority recorder without the use of additional hardware or software. The recording mechanism is integrated with and comprises a part of the operating software.

These and other objects of the present invention are achieved by a computer implemented method of recording operating software program scheduling information. Advantageously, because the scheduling information capture mechanism is compiled with and integrated as a part of the operating software, the operating software scheduling information is captured during execution of the operating software. The method of capturing operating software scheduling information during execution of operating software includes the following steps. The operating software scheduling information capture software is compiled as part of the operating software. The operating software scheduling information capture is invoked and operating software scheduling information is recorded.

Further, the scheduling information is captured without the use of additional hardware or software thereby improving the accuracy of the scheduling information captured. The method of capturing operating software scheduling information during execution of operating software, wherein the method is performed using operating software scheduling information recording software compiled and integrated with the operating software, includes the following steps. The operating software scheduling information capture software is invoked and operating software scheduling information is recorded. The operating software scheduling information capture software is not resident on an external device and is not a separate task scheduled by an operating system scheduler.

In a computer system aspect, the capture of operating software scheduling information during execution of the operating software is performed using a computer system including a processor for receiving and transmitting data and a memory coupled to the processor. The memory has sequences of instructions stored which, when executed by the processor, cause the processor to invoke operating software scheduling information capture software, and to record operating software scheduling information. Further, in one embodiment, the operating software scheduling information capture software is internally processed on the processor. In another embodiment, the operating software scheduling information capture software is not a separate task scheduled by an operating software scheduler.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of a computer architecture usable with the present invention;

FIG. 2 is a high level diagram of the present invention;

FIG. 3 is an example record of a system event history; and

FIG. 4 is an example result of the system event history.

### DETAILED DESCRIPTION OF THE DRAWINGS

A method and apparatus for recording operating software program scheduling information while the operating software is running are described. In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Hardware Overview

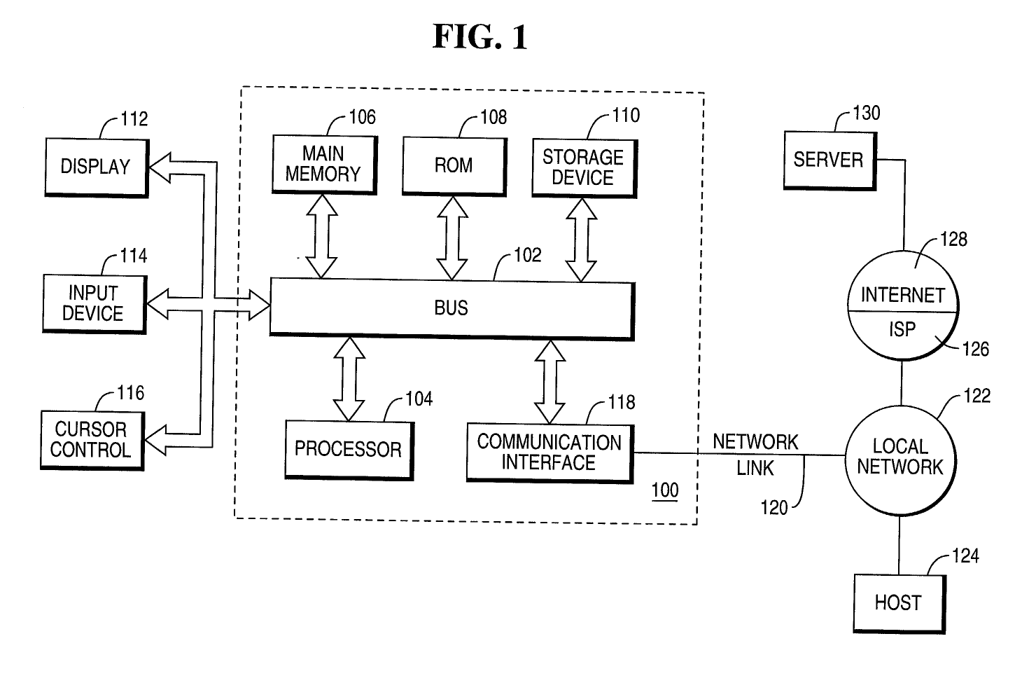

FIG. 1 is a block diagram illustrating an exemplary computer system 100 upon which an embodiment of the invention may be implemented. The present invention is usable with currently available personal computers, mini-mainframes and the like.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a magnetic disk or optical disk, is provided and coupled to the bus 102 for storing information and instructions.

Computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Another type of user input device is cursor control 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

The invention is related to the use of a computer system 100, such as the illustrated system, to record operating software program scheduling information. According to one embodiment of the invention, operating software program scheduling information capture and display is provided by computer system 100 in response to processor 104 executing sequences of instructions contained in main memory 106. Such instructions may be read into main memory 106 from another computer-readable medium, such as storage device 110. However, the computer-readable medium is not limited to devices such as storage device 110. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides a two-way data communication as is known. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. In the preferred embodiment communication interface 118 is coupled to a virtual blackboard. Wireless links may also be implemented. In any such implementation, communication interface 118 sends and receives electrical, electromagnetic or optical signals which carry digital data streams representing various types of information. Of particular note, the communications through interface 118 may permit transmission or receipt of the operating software program scheduling information. For example, two or more computer systems 100 may be networked together in a conventional manner with each using the communication interface 118.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication services through the world wide packet data communication network now commonly referred to as the “Internet” 128. Local network 122 and Internet 128 both use electrical, electromagnetic or optical signals which carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application provides for operating software scheduling information capture as described herein.

The received code may be executed by processor 104 as it is received, and/or stored in storage device 110, or other non-volatile storage for later execution. In this manner, computer system 100 may obtain application code in the form of a carrier wave.

The Operating Software Scheduling Priority Recorder (OSSPR) of the present invention records the operating software's program scheduling information while the operating software is executing. Advantageously, the OSSPR is integrated with the operating software and does not require the use of external devices or software for the capture of scheduling information. The OSSPR is compiled as a part of the operating software. The program scheduling control behaviors are:

Program scheduling;

Program switching;

Program preemption; and

All other program scheduling techniques.

The following definitions are used herein:

The operating software can be either an operating system or an operating or executing application.

Programs are applications, tasks, or processes that execute within the operating software environment.

Run-time priority is the importance of a program's scheduling and execution relative to other programs in the system. The operating software uses the run-time priority to determine which program to execute on the computer device.

Scheduling information can be a count(s), a variable(s), or a system structure(s) that the operating software updates and maintains in conjunction with the scheduling of a program.

Program preemption is an action performed by the operating software suspending a program such that control is given to another program with a higher run-time priority.

A ledger is the location where scheduling information content is recorded by the OSSPR.

Idle loop refers to a point, a program, or a routine executed when the system is inactive. In this condition, the system is not busy, or it is performing low-level background diagnostics. The idle loop is exited when an event occurs triggering the operating software to run another program.

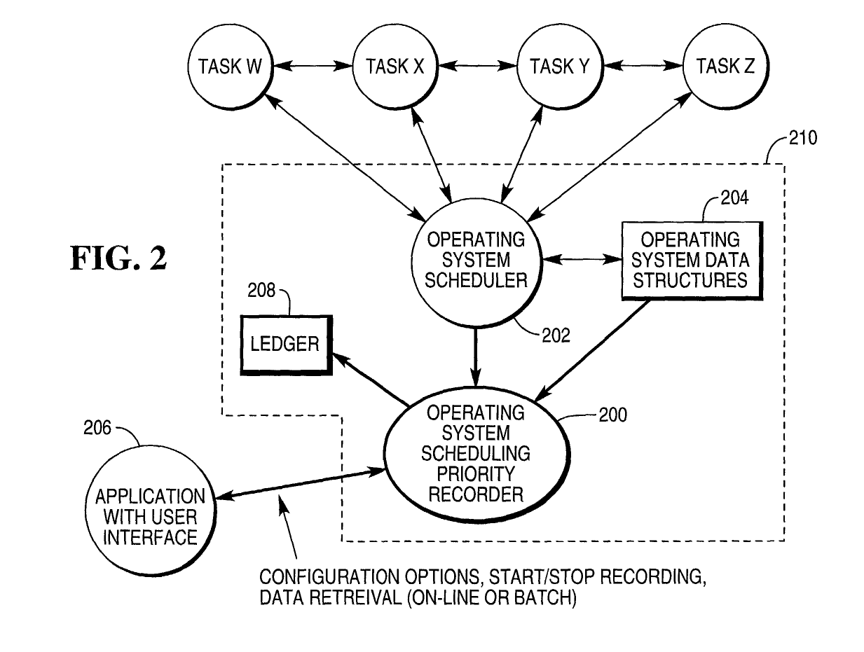

FIG. 2 is a high level functional diagram of the OSSPR 200 within a kernel 210 of a computer system. Included within the kernel 210 is an operating system scheduler 202, operating system data structures 204, a user level application 206, and a ledger 208. Tasks W-Z interact with operating system scheduler 202 and operating system scheduler 202 interacts with operating system data structures 204.

The OSSPR 200 records the history of operating software events as they occur. The OSSPR 200 records program scheduling, program switching, program preemption, interrupts. Details such as task identification, task priority, and run-time length are included within the historic information stored in ledger 208. The OSSPR 200 is designed to be integrated within the target operating system's kernel, and in particular, with the operating system scheduler 202, as shown in FIG. 2. This enables a user to assess the behavior of a computer system, described in detail above, as a whole. Since the OSSPR 200 exists as an extension to the operating system, a separate external device such as an emulator is not required to obtain this crucial historical information by a systems analyst.

The OSSPR software suite contains the following components:

Operating System Kernel extensions (the OSSPR 200);

Application program interface (API) for options and control;

On-line Analysis and Control Program; and

Interactive Configuration Utility Program.

The On-line Analysis and Control Program (not shown) is a user level application within application 206 of FIG. 2 and combined with the ledger 208 provides an interface for the Operating Software Performance Monitor.

The Interactive Configuration Utility Program (not shown), located within application 206 of FIG. 2, is used to define the period and media for recording the ledger 208. The media may be storage device 110, main memory 106, or host 124 or server 130 via communication interface 118. The media stores ledger entries using either a circular or fixed length ledger 208. A circular ledger 208 is used for 1) data occurring after a specific event or time, 2) data occurring prior to a specific event or time, or 3) continuous recording data, such that the last specified number of events remain in the buffer. The data is recorded constantly overwriting the last recorded data. A fixed length ledger 208 is used for data occurring after a specific event to capture a specified number of events. The data is recorded constantly until the specified number of event data is recorded.

The OSSPR 200 code is compiled as an integral part of the operating system kernel and is an extension to the operating system's kernel. The ledger 208 and operating system data structures 204 are shown in FIG. 2 as residing within kernel 210; however, they may be located external of kernel 210 in alternate embodiments.

In one current embodiment, i.e., a retail store bar code scanner, the target operating system used is Embedded Power Corporation's RTXC. The Interactive Configuration Utility and the On-line Analysis and Control Program are invoked by means of scanning a specific bar code tag sequence in order to select the information to be recorded, specify recording period/events and recording media, and controlling the reset/restart of recording.

The OSSPR 200 is invoked with each task switch caused by task-to-task communication or an interrupt. The task switch may occur when a lower priority task is preempted by the operating system for a higher priority task. At such time, the OSSPR 200 updates the ledger 208, described in detail below, with an event number, the identification of the last running task, the task priority and run-time, and the system times for each event. Also, the OSSPR 200 adjusts the task waiting count to reflect the number of tasks ready to run. After completing updates to the ledger 208, the OSSPR 200 returns control to the operating system kernel.

The On-line Analysis and Control Program uses the OSSPR 200 configuration information and the ledger 208 data to produce graphs and charts for the user to analyze the system's behavior. Furthermore, the output from the On-line Analysis and Control Program is formatted for the Operating Software Performance Monitor (OSPM) such that automatic adjustments to task priorities are made to improve system input/output throughput. By means of the Operating Software Performance Monitor, the user can select the conditions and/or time periods that certain tasks should run. The OSSPR's On-line Analysis and Control Program captures the results, which are accessible via reports.

Retrieval of program schedule information.

While the operating software is running, the user invokes the Interactive Configuration Utility Program and selects the specific information to be recorded in the OSSPR's ledger 208. The user selects either the start and end period for the recording, or a specific event to activate the recording. The user selects the recording media, i.e. resident or external memory, disk, tape, etc. The user selects the recording buffer type, either circular (continuous) recording (the oldest data is replaced once the media is full), or a fixed length recording buffer (recording is terminated when the media is full.).

At some point the user will initiate the OSSPR's ledger 208 recording function by means of the On-line Analysis and Control Program. The On-line Analysis Program will interactively interface with the user while retrieving specified data from the ledger 208 and allow the user to obtain information about the behavior of a specific task and/or the system in general. For example, the user can evaluate how often a task runs, the order and time each task runs, the number of tasks waiting to run, the rate and sequence of interrupts. This information is crucial for the development of robust embedded software.

The OSSPR 200 records program schedule information for a defined time period as set using the Interactive Configuration Utility Program. As described above, the time period of recording can range from until the occurrence of a specified event to the entire lifetime of the system.

Scheduling information recorded in the ledger during the specified time period includes all or a portion of the following:

A count of the number of program schedules, timer ticks, program preempts and interrupts.

The highest priority attained, program identity, and length of run-time.

The lowest priority attained, program identity, and length of run-time.

Number of times in the idle loop and length of run-time.

A sequential record of scheduled programs and task identifiers, priorities, and events (interrupts, pre-empts, etc.).

Usage and availability of memory partition information.

The number and identity of programs waiting to run at the time of a schedule.

The OSSPR 200 provides application programming interfaces (APIs) allowing programs to configure/access recording options including:

Selecting the information to be recorded.

Specifying recording period/events.

Controlling the reset/restart of recording.

Specifying the recording media.

Retrieval of program schedule information.

During execution, the OSSPR 200 records the above-identified scheduling information to a ledger 208 which is placed in memory and/or on external media, i.e., disk, tape, network, etc. The ledger 208 recordings are accessed by means of an application interface available to programs allowing schedule information retrieval for analysis. The Software Sanity Monitor, described in NCR Docket No. 8357 assigned to the instant assignee and is hereby incorporated by reference into this specification in its entirety, is one such program. Other programs include one described in the co-pending application entitled, “Operating Software Performance Monitor”, and is hereby incorporated by reference in its entirety.

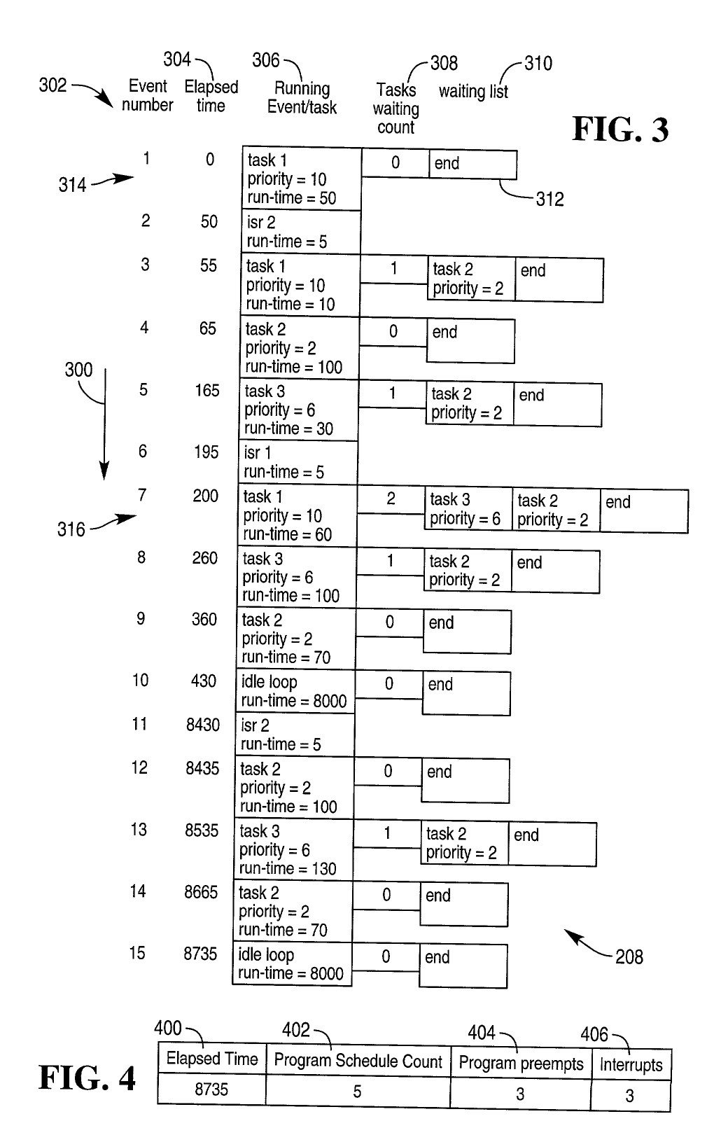

An example of a ledger 208 generated by the present invention is shown in FIG. 3. The OSSPR 200 records the history of system events as they occur within operating software. With respect to FIG. 3, the time history of events proceeds down the page as indicated by arrow 300. The ledger 208 includes time ordered entries for each event occurrence arranged in rows proceeding in direction 300, and because the OSSPR 200 executes as a part of the operating software, the OSSPR is not scheduled by the operating system scheduler 202 for execution. Thus, the OSSPR 200 does not appear as a task in the ledger 208. The ledger 208 includes columns of information about the system events, such as an event number 302, an elapsed time 304, a running event/task 306, a tasks waiting count 308, and a waiting list 310. Each row or entry in the ledger 208 includes an event number entry, elapsed time entry, a running event/task entry, and a tasks waiting count. Additionally, each entry includes a waiting list end mark 312. As such, in the present example, there are three tasks (designated task 1, 2, and 3), two interrupt services routines (isr's) (designated isr 1 and 2). The isr's are isr 1 associated with Device 1, and isr 2 associated with Device 2.

The OSSPR 200 increments the tasks waiting count 308 and event number 302 entry for the number of program schedules, program preempts and interrupts. The elapsed time 304 is the time elapsed since the scheduling information recording was started. The running event/task 306 is information about the currently executing task. The tasks waiting count 308 is the number of tasks waiting to be executed by the operating software. The waiting list 310, or scheduler queue, includes information about the tasks waiting to be executed by the operating software. There may be multiple entries in the waiting list 310 indicating more than one task waiting to execute. The end of waiting list 310 is indicated with an end mark 312.

For example, at the entry indicated by reference numeral 314, the event number 302 is one (1), the elapsed time 304 is zero (0) because the OSSPR 200 has just started, the currently running task 306 is task 1, the tasks waiting count 308 is zero (0), and the waiting list 310 includes only an end mark 312 indicating there are no waiting tasks. At the entry indicated by reference numeral 316, the event number 302 is seven (7) and the elapsed time 304 is 200. The currently running task 306 is task 1 and there are two tasks waiting to be executed as indicated in the tasks waiting count 308. The waiting list 310 includes task 3, task 2, and the end mark 312.

A detailed description of the example ledger 208 shown in FIG. 3 is now provided. Because the ledger 208 is recording the history of the system events, it is possible to reconstruct the occurrence of system events in order. For example, at elapsed time equal to zero, the OSSPR 200 is started. In the example shown in FIG. 3, the OSSPR 200 was invoked while task 1 was running or executing (event #1). An interrupt from Device 2 occurs causing isr 2 to start (event #2), which schedules task 2 (event #3). Since task 2's run-time priority is lower than task l's priority, task 1 continues to run without preemption.

After task 1 runs to completion, task 2 is scheduled (event #4). Eventually, task 2 invokes a higher priority program, task 3, causing a preemption of task 2 (event #5). At this time, the ledger 208 is representative of task 3 running while task 2 is waiting or preempted. Prior to task 3 completion, Device 1 interrupts, and consequently, isr 1 gains control (event #6). Next, isr 1 schedules task 1. Because task 1's run-time priority is greater than the currently running program, i.e., task 3, task 3 is preempted to allow task 1 to run (event #7). Both task 3 and task 2 have been preempted and they are waiting to run.

Upon completion of task 1, task 3 resumes execution (event #8). Upon completion of task 3, task 2 resumes execution and runs to completion (event #9). At this time, the scheduler queue is empty and the idle loop runs (event #10).

An interrupt from Device 2 is received causing isr 2 to begin execution (event #11) scheduling task 2 (event #12). Next, task 2 invokes a higher priority program, task 3, causing a preemption of task 2 (event #13). At this time, the ledger 208 displays task 3 running while task 2 is preempted and waiting. Upon completion of task 3, task 2 resumes and runs to completion (event #14). At this time, the scheduler queue is empty and the idle loop runs (event #15). The OSSPR 200 is stopped.

An example compilation of the results based on the example described above in connection with FIG. 3 is shown in FIG. 4. The compilation includes four columns of information, i.e., an elapsed time 400, a program schedule count 402, a program preempts count 404, and an interrupts count 406. The elapsed time 400 is the total amount of time the OSSPR 200 was recording. The program schedule count 402 is the number of programs scheduled for execution during the course of the recording. The program preempts count 404 and interrupts count 406 is the number of programs preempted and number of interrupt occurrence, respectively, during the course of the recording.

The OSSPR 200 provides application interfaces allowing the selection of configuration options. The ledger 208 can be programmed to list only the running tasks and run-time and priority recording is optional. Capture of the waiting list and waiting count is optional, as well.

The residence or location of the ledger 208 storage is optional. The ledger 208 can be located in local or external memory, e.g., main memory 106, or it can be recorded to external media, e.g., storage device 110 or server 130. The ledger 208 information can be retrieved by means of memory/device access via network interrogation or a separate internal task with external user interfaces.

It is to be understood that in alternative embodiments, other operating system information, such as timer tick values, interrupt priorities, memory location/port monitoring, etc., may be included in the ledger 208.

Advantageously, the present invention provides a method and apparatus for recording operating software program scheduling information while the operating software is executing. Further advantageously, the present invention provides a mechanism to record operating software program scheduling information without requiring an external device or external software.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of capturing operating software scheduling information during execution of operating software, the method comprising the steps of:
compiling operating software scheduling information capture software as part of the operating software;
invoking operating software scheduling information capture; and
recording operating software scheduling information.

2. The method as claimed in claim 1, wherein the operating software scheduling information capture procedure is invoked on an operating software task switch.

3. The method as claimed in claim 1, wherein the operating software scheduling information recorded includes information updated or maintained by the operating software in relation to the scheduling of a program.

4. The method as claimed in claim 1, wherein the operating software scheduling information recorded includes task identification, task priority, and task run-time length.

5. The method as claimed in claim 1, wherein the operating software scheduling information includes a task waiting count.

6. The method as claimed in claim 1, wherein the operating software scheduling information is recorded to a ledger.

7. The method as claimed in claim 6, wherein the ledger is at least one of a circular or fixed length ledger.

8. The method as claimed in claim 1, wherein the scheduling information includes at least one of the number of program schedules, program preempts, and interrupts.

9. The method as claimed in claim 1, wherein the scheduling information includes at least one of the highest priority attained, program identity, and length of run-time.

10. The method as claimed in claim 1, wherein the scheduling information includes at least one of the lowest priority attained, program identity, and length of run-time.

11. The method as claimed in claim 1, wherein the scheduling information includes at least one of the number of times in the idle loop and length of run-time.

12. The method as claimed in claim 1, wherein the scheduling information includes a sequential record of at least one of scheduled programs, priorities, and events.

13. The method as claimed in claim 1, wherein the scheduling information includes at least one of the number and identity of programs waiting to run.

14. The method as claimed in claim 1, wherein the operating software scheduling information capture is invoked on an event occurrence.

15. A method of capturing operating software scheduling information during execution of said operating software, wherein said method is performed using operating software scheduling information recording software compiled and integrated with the operating software, the method comprising the steps of:
invoking operating software scheduling information capture software; and
recording operating software scheduling information.

16. The method as claimed in claim 15, wherein said operating software scheduling information capture software is not resident on an external device.

17. The method as claimed in claim 15, wherein said operating software scheduling information capture software is not a separate task scheduled by an operating software scheduler.

18. A computer system for capturing operating software scheduling information during execution of said operating software comprising:
a processor for receiving and transmitting data; and
a memory coupled to the processor, the memory having stored therein sequences of instructions which, when executed by the processor, cause the processor to invoke operating software scheduling information capture software, and to record operating software scheduling information.

19. The computer system as claimed in claim 18, wherein said operating software scheduling information capture software is internally processed on said processor.

20. The computer system as claimed in claim 18, wherein said operating software scheduling information capture software is not a separate task scheduled by an operating software scheduler.
